(19) United States
(12) Patent Application Publication
(10) Pub. No.: US 2013/0173190 A1
(43) Pub. Date: Jul. 4, 2013

(54) METHODS AND SYSTEMS FOR ESTIMATING CHARGE CAPACITY OF AN ELECTRICAL ENERGY-STORAGE DEVICE

(71) Applicants: Dachuan Yu, Normal, IL (US); Biagio Ciarla, Appleton, WI (US); Justin Dale Middleton, Peoria, IL (US)

(72) Inventors: Dachuan Yu, Normal, IL (US); Biagio Ciarla, Appleton, WI (US); Justin Dale Middleton, Peoria, IL (US)

(73) Assignee: Caterpillar Inc.

(21) Appl. No.: 13/341,340

(22) Filed: Dec. 30, 2011

(51) Int. Cl. G06F 19/00; G01N 27/416

(52) U.S. Cl. 702/61; 324/427

(57) ABSTRACT

A method of operating a power system with an electrical energy-storage device is disclosed. The method may include estimating with at least one information-processing device a present charge capacity of the electrical energy-storage device. This may include determining an estimated fatigue-adjusted discharge value by determining an estimated amount of electrical energy discharged from the electrical energy-storage device and applying a fatigue factor to the estimated amount of electrical energy discharged. The fatigue factor may be determined based on a magnitude of electricity discharged from the electrical energy-storage device. The method may also include estimating the present charge capacity of the electrical energy-storage device based on the estimated fatigue-adjusted discharge value and an estimated full capacity of the electrical energy-storage device.

### TECHNICAL FIELD

The present disclosure relates to electrical energy-storage devices and, more particularly, to estimating charge capacity of an electrical energy-storage device.

### BACKGROUND

Many power systems include one or more electrical loads and an electrical energy-storage device (e.g., a battery or capacitor) for supplying electricity to one or more of those electrical loads. When controlling such systems, it may prove helpful to know the present charge capacity of the electrical energy-storage device, i.e., the amount of electrical energy the electrical energy-storage device is presently capable of supplying to external loads. Some methods of estimating the present charge capacity of an electrical energy-storage device involve determining an amount of electricity discharged from the electrical energy-storage device and subtracting that from an assumed full capacity of the electrical energy-storage device. This may account for decreases in charge capacity due to decreases in the absolute amount of energy stored in the electrical energy-storage device.

However, other factors may affect the charge capacity of the electrical energy-storage device. For example, when an electrical energy-storage device is discharging electricity, it may experience a fatigue effect that limits the amount of electrical energy it can actually release to a value less than the total amount of electricity actually stored internally. The magnitude of the fatigue effect and the corresponding reduction in the present charge capacity of the electrical energy-storage device may depend, at least in part, on the rate at which the electrical energy-storage device is discharging, or the magnitude of electric current or power the electrical energy-storage device is supplying. The higher the discharge rate, the greater the fatigue effect and the more the present charge capacity is diminished. Ignoring this fatigue effect when estimating the present charge capacity of an electrical energy-storage device may significantly detract from the accuracy of the estimate.

One method that purports to account for the effects of discharge rate on the capacity of a battery is disclosed in GB 1,465,240 to Leichle (“the '240 patent”). The '240 patent discloses integrating the current discharged from a battery to determine an amount of electrical energy discharged from the battery. The '240 patent further discloses dividing this amount of electrical energy discharged from the battery by the time over which the integration occurred, thereby determining the average discharge rate over the time period. The method of the '240 patent then uses the average discharge rate and a function generator to calculate a maximum capacity of the battery. The '240 patent discloses that the function generator accounts for the effects of discharge rate on charge capacity. With this adjustment made, the method then determines the available capacity of the battery by subtracting the calculated amount of electrical energy discharged from the battery from the calculated maximum capacity of the battery.

Although the '240 patent discloses a method that purportedly accounts for the effects of discharge rate on the available charge capacity of a battery, certain disadvantages may persist. For example, because the disclosed method requires calculating both the amount of electrical energy discharged and the maximum capacity of the battery each time the available charge capacity is calculated, it may be unnecessarily computationally intensive. Additionally, by averaging the discharge rate for a period before it applies information intended to adjust for the effects of that discharge rate, the method of the '240 patent may not account for fluctuations in discharge rate during the period.

The system and methods of the present disclosure may solve one or more of the problems set forth above.

### SUMMARY

One disclosed embodiment relates to a method of operating a power system with an electrical energy-storage device. The method may include estimating with at least one information-processing device a present charge capacity of the electrical energy-storage device. This may include determining an estimated fatigue-adjusted discharge value by determining an estimated amount of electrical energy discharged from the electrical energy-storage device and applying a fatigue factor to the estimated amount of electrical energy discharged. The fatigue factor may be determined based on a magnitude of electricity discharged from the electrical energy-storage device. The method may also include estimating the present charge capacity of the electrical energy-storage device based on the estimated fatigue-adjusted discharge value and an estimated full capacity of the electrical energy-storage device.

Another embodiment relates to a method of operating a power system with an electrical energy-storage device. The method may include estimating with at least one information-processing device a present charge capacity of the electrical energy-storage device. This may include, for each of a plurality of time periods, determining a fatigue factor based at least in part on a magnitude of electricity discharged from the electrical energy-storage device, and applying the fatigue factor to a first value related to charge capacity of the electrical energy-storage device to determine a second value related to charge capacity of the electrical energy-storage device. The method may also include summing the second value over the plurality of time periods to determine a third value related to charge capacity of the electrical energy-storage device.

A further disclosed embodiment relates to a power system. The power system may include an electrical energy-storage device. The power system may also include at least one information-processing device configured to estimate a present charge capacity of the electrical energy-storage device. In estimating the present charge capacity of the electrical energy-storage device, the at least one information-processing device may determine an estimated fatigue-adjusted discharge value by determining an estimated amount of electrical energy discharged from the electrical energy-storage device and applying a fatigue factor to the estimated amount of electrical energy discharged. The fatigue factor may be determined based on a magnitude of electricity discharged from the electrical energy-storage device. The at least one information-processing device may estimate the present charge capacity of the electrical energy-storage device based on the estimated fatigue-adjusted discharge value and an estimated full capacity of the electrical energy-storage device.

### BRIEF DESCRIPTION OF THE DRAWINGS

FIG. 1 shows one embodiment of a power system according to the present disclosure; and

FIG. 2 graphically illustrates data that may be used in one embodiment of a method according to the present disclosure.

### DETAILED DESCRIPTION

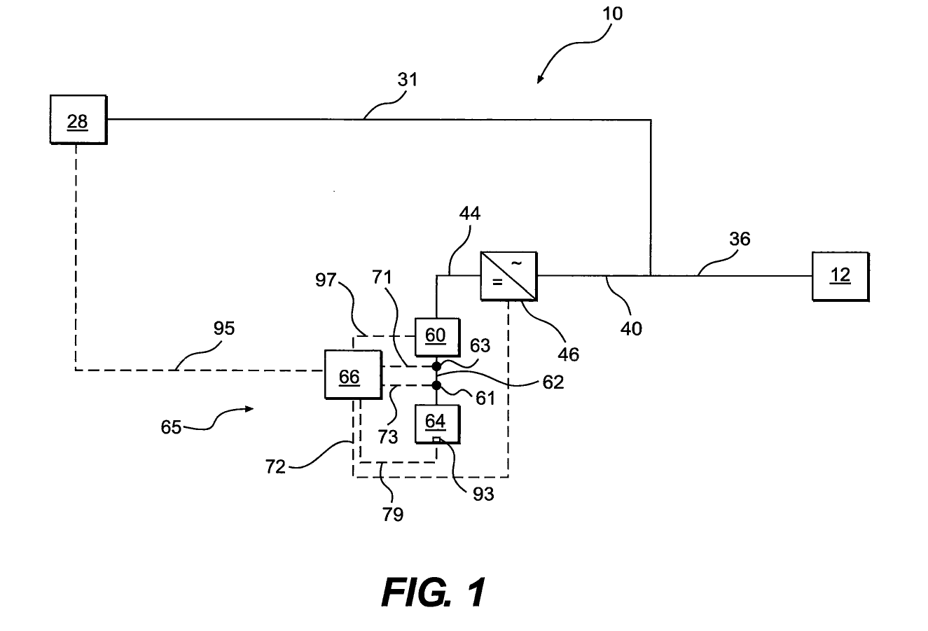

FIG. 1 shows one embodiment of a power system 10 according to the present disclosure. Power system 10 may be any type of system that uses electricity to perform one or more tasks. Power system 10 may be a stationary system, or power system 10 may be part of a mobile machine (not shown). In the example shown in FIG. 1, power system 10 may be a stationary microgrid, i.e., a localized power network for a worksite, separate from a main utility grid.

Power system 10 may include one or more components that provide electrical power, one or more components that use electrical power, and one or more components for transferring power between the components that provide electrical power and the components that use electrical power. In the example shown in FIG. 1, the components that provide electrical power include a power source 28 and an electrical energy-storage device 64. The one or more components that use electrical power may include a load 12.

Power source 28 may include any component or components operable to provide electrical power. In some embodiments, power source 28 may include one or more electric generator units. For example, a generator unit of power source 28 may include an engine, such as a gasoline engine, a diesel engine, a gaseous fuel powered engine, or a turbine engine, drivingly connected to an electric generator. Additionally, or alternatively, power source 28 may include various other types of components operable to produce electrical power, including, but not limited to, fuel cells and photovoltaic devices. Power source 28 may be configured to supply electricity in various forms. For example, power source 28 may be configured to supply AC (alternating current) electricity, such as multiphase AC electricity.

Electrical energy-storage device 64 may include any components operable to receive energy in the form of electricity, store at least a portion of that energy, and subsequently discharge energy in the form of electricity. For example, electrical energy-storage device 64 may include a battery or a capacitor. In some embodiments, electrical energy-storage device 64 may include multiple batteries and/or multiple capacitors. In embodiments where electrical energy-storage device 64 includes multiple devices, the devices may be connected in series and/or parallel arrangements.

Load 12 may include any components that use electrical power. For example, load 12 may include components like lighting, heating and cooling devices, information-processing and communication devices and, other types of appliances, and machinery. Additionally or alternatively, load 12 may include one or more components like electric motors and sensors.

Power system 10 may include various components for connecting power source 28 to load 12. In the example shown in FIG. 1, power system 10 may include a power line 31 and a power line 36 connecting power source 28 to load 12.

Electrical energy-storage device 64 may connect to load 12 and/or power source 28 in various ways. For example, power system 10 may include a power line 62, a power regulator 60, a power line 44, an inverter 46, and a power line 44 connecting electrical energy-storage device 64 to power lines 31, 36 and, thus, to load 12 and power source 28.

Power regulator 60 may include any components operable to control one or more aspects of transmission of electricity between power line 44 and electrical energy-storage device 64. In some embodiments, power regulator 60 may be a DC-to-DC power converter configured to control whether and in which direction electricity flows between power line 44 and electrical energy-storage device 64. Power regulator 60 may include one or more active switching devices, such as IGBTs and/or MOSFETs for controlling whether and in which direction electricity flows between power line 44 and energy-storage device 64.

Inverter 46 may be any type of device operable to receive DC electricity from power line 44 and supply AC electricity to power line 40. In some embodiments, inverter 46 may also be operable to transmit power in the opposite direction, i.e., from power line 40 to power line 44. Specifically, inverter 46 may be operable to receive AC electricity from power line 40 and supply DC electricity to power line 44. Inverter 46 may, for example, include controllable switching elements such as IGBTs or MOSFETs for converting between DC and AC electricity.

While FIG. 1 illustrates each of the various power lines of uninterruptible power supply 10 with a single line, it will be understood that various of these power lines may include multiple conductors, such as for carrying multiple-phase electricity. For example, power lines 31, 36, and 40 may, in some embodiments, each have multiple conductors for carrying multiphase AC electricity.

In addition to the components shown in FIG. 1, the network for transferring electrical power between power source 28, electrical energy-storage device 64, and load 12 may include various other components. For example, power system 10 may also include various components such as switches, transformers, power regulators, power converters, and circuit breakers connected between power source 28, electrical energy-storage device 64, and load 12.

Power system 10 may also include controls 65 for monitoring and/or controlling one or more aspects of the operation of power system 10. Controls 65 may include an information-processing device 66. Information-processing device 66 may include any component or components operable to process information. For example, in some embodiments, information-processing device 66 may include one or more microprocessors and one or more memory devices. Information-processing device 66 may be configured (i.e., programmed) in any suitable manner that allows it to perform the methods of the present disclosure described below.

Controls 65 may also include one or more sensing devices communicatively linked to information-processing device 66. For example, controls 65 may include a voltage sensor 61 communicatively linked to information-processing device 66 by a communication line 79. Voltage sensor 61 may sense a voltage level of electrical energy-storage device 64 and transmit a signal to information-processing device 66 indicating the sensed voltage level. Controls 65 may also include a current sensor 63 communicatively linked to information-processing device 66 via a communication line 71. Current sensor 63 may sense a magnitude of electric current being discharged from (or supplied to) electrical energy-storage device 64 and transmit a signal to information-processing device 66 indicating the sensed magnitude of electric current. Controls 65 may also include a temperature sensor 93 communicatively linked to information-processing device 66 by a communication line 79. Temperature sensor 93 may sense a temperature of electrical energy-storage device 64 and transmit to information-processing device 66 a signal indicating the sensed temperature.

Thus, voltage sensor 61, current sensor 63, and temperature sensor 93 may allow information-processing device 66 to monitor conditions associated with electrical energy-storage device 64. Controls 65 may also include various components that allow information-processing device 66 to monitor and/or control other aspects of power system 10. For example, controls 65 may include communication lines 72, 95, and 97 communicatively linking information-processing device 66 to inverter 46, power source 28, and power regulator 60, respectively.

In some embodiments, information-processing device 66 may be configured (i.e., programmed) to control the transmission of electrical power between the various components of power system 10 by controlling power source 28, power regulator 60, inverter 46, and/or other components of power system 10. Information-processing device 66 may, for example, control power source 28 to supply electrical power to power line 31, such that load 12 may receive electrical power from power source 28 via power lines 31, 36. Similarly, information-processing device 66 may control power regulator 60 and inverter 46 to transmit electrical power from electrical energy-storage device 64 to power line 40, such that load 12 may receive electrical power from electrical energy-storage device 64 via power lines 40, 36. In some circumstances, information-processing device 66 may engage both power source 28 and electrical energy-storage device 64 to simultaneously supply power to load 12. In other circumstances, information-processing device 66 may engage only power source 28 or only electrical energy-storage device 64 to supply electrical power to load 12.

Additionally, in some circumstances, information-processing device 66 may control power system 10 to charge electrical energy-storage device 64. This may involve, for example, supplying power to power line 31 and 40 with power source 28 while operating inverter 46 and power regulator 60 to transmit electrical power from power line 40 to electrical energy-storage device 64.

Power system 10 is not limited to the configuration shown in FIG. 1. For example, power system 10 may include different numbers and/or types of power sources, power loads, and power-transmission components. Similarly, power system 10 may be configured to transmit electrical power in different forms than discussed above. For instance, power system 10 may be configured to transmit DC electricity to load 12, instead of AC electricity. Furthermore, controls 65 may have different configurations. In addition to, or in place of, information-processing device 66, power system 10 may have other information-processing devices or control components. In some embodiments, controls 65 may distribute the various control functions of power system 10 within a network of information-processing devices.

### INDUSTRIAL APPLICABILITY

Power systems 10 may have use in any application requiring power to perform one or more tasks. As noted above, power system 10 may use either or both of power source 28 and electrical energy-storage device 64 at any given time to provide electrical power for load 12. Strategic coordination of the use of power from electrical energy-storage device 64 and/or power source 12 can provide a number of benefits, including significant efficiency gains. Accurate knowledge of the present charge capacity of electrical energy-storage device 64 may facilitate such strategic control.

Accordingly, during operation of power system 10, controls 65 and information-processing device 66 may repeatedly or continuously estimate a present charge capacity of electrical energy-storage device 64. To enhance the accuracy of the estimated charge capacity of electrical energy-storage device 64, information-processing device 66 may determine a fatigue factor representative of an estimated effect of a discharge rate of the electrical energy-storage device 64 on its charge capacity. Information-processing device 66 may determine the fatigue factor based on various parameters. In some embodiments, information-processing device 66 may determine the fatigue factor based on performance data for electrical energy-storage device 64 and one or more sensed operating parameters.

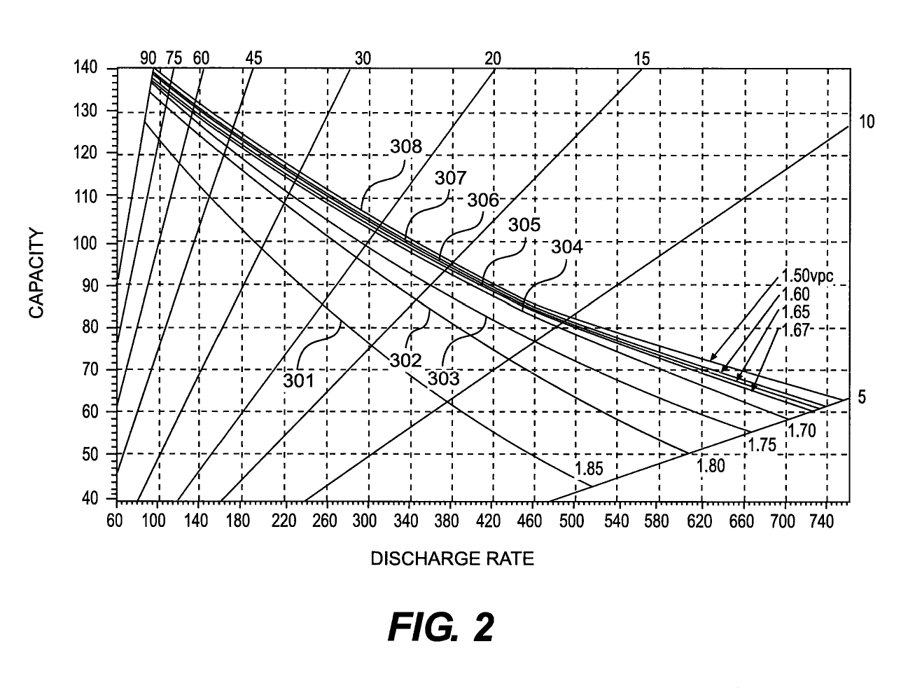

FIG. 2 graphically illustrates one example of performance data that may be employed to determine a fatigue factor. The horizontal axis of FIG. 2 plots a range of possible discharge rates of electrical energy-storage device 64. The vertical axis of FIG. 2 plots a range of charge capacities that electrical energy-storage device 64 may have. A series of performance curves 301-308 represent how the charge capacity of electrical energy-storage device 64 may vary dependent on certain operating parameters.

The chart includes multiple performance curves 301-308 because the effective charge capacity of electrical energy-storage device 64 depends on the lowest acceptable charge level of electrical energy-storage device 64. If, for example, the lowest acceptable charge level of electrical energy-storage device 64 is 1.85 volts per cell, performance curve 301 represents the performance characteristics of electrical energy storage device 64. On the other hand, if the lowest acceptable charge level of electrical energy-storage device 64 is 1.5 volts per cell, performance curve 308 represents the performance characteristics of electrical energy-storage device 64. Performance curves 302-307 represent the performance characteristics for electrical energy-storage device 64 where the lowest acceptable charge level of electrical energy-storage device 64 falls between 1.85 and 1.5 volts per cell.

For the process of information-processing device 66 determining the fatigue factor based on the performance data shown in FIG. 2, the lowest acceptable charge level of electrical energy-storage device 64 may be determined in various ways. In some embodiments, information-processing device 66 may dynamically determine the lowest acceptable charge level based on one or more operating parameters of power system 10 and/or other variables. For example, in some embodiments, information-processing device 66 may determine the lowest acceptable charge level of electrical energy-storage device 64 based on a temperature of electrical energy-storage device 64, as sensed by temperature sensor 93. Once the lowest acceptable charge level of electrical energy-storage device 64 is determined, information-processing device 66 may use a corresponding one of performance curves 301-308. For example, if the lowest acceptable charge level is established as 1.5 volts per cell, information-processing device 66 may use performance curve 301.

Using an appropriate one of performance curves 301-308, information-processing device 66 may use various approaches to determine the fatigue factor. In some embodiments, information-processing device 66 may use one of performance curves 301-308 to determine the fatigue factor as an estimate of how much charge capacity electrical energy-storage device 64 could have at its present discharge rate proportional to how much charge capacity it could have at a baseline discharge rate. This may involve determining a present reference capacity Cᵣₚ that represents a theoretical capacity that electrical energy-storage device 64 could have at its present discharge rate. It may also involve determining a baseline reference capacity C_{rb} that represents the theoretical capacity that electrical energy-storage device 64 could have at a baseline discharge rate.

Information-processing device 66 may determine the present reference capacity Cᵣₚ based on the magnitude of electricity being discharged from electrical energy-storage device 64. In some embodiments, information-processing device 66 may use the signals from voltage sensor 61 and current sensor 63 to determine a magnitude of electric power being discharged from electrical energy-storage device 64. With this value determined, information-processing device 66 may use the data reflected in FIG. 2 to determine the present reference capacity C. For example, if performance curve 308 has been selected and the magnitude of electric power being discharged is 340, information-processing device 66 may determine where performance curve 308 intersects the vertical grid line corresponding to a power magnitude of 340. FIG. 2 shows that this intersection corresponds to a reference capacity value of 100.

Information-processing device 66 may determine the baseline reference capacity C_{rb} in various ways. In some embodiments, information-processing device 66 may determine the baseline reference capacity C_{rb} by determining the theoretical maximum capacity of electrical energy-storage device 64 for a given performance curve 301-308. Thus, in the example where information-processing device 66 is using performance curve 308, information-processing device 66 may determine the baseline reference capacity by following performance curve 308 to its uppermost and leftmost point. In such an example, information-processing device 66 would arrive at a baseline reference capacity of 140.

With the present reference capacity Cᵣₚ, and the baseline reference capacity C_{rb} determined, information-processing device 66 may determine the fatigue factor in various ways. In some embodiments, information-processing device 66 may compare the present reference capacity Cᵣₚ and the baseline reference capacity C_{rb} as a measure of how much the theoretical capacity of electrical energy-storage device is diminished by the present discharge rate. For example, information-processing device 66 may use the following equation to determine a fatigue factor FF:

$$FF = \frac{{C}_{rp}}{{C}_{rb}}$$

Calculating a fatigue factor FF in this manner may provide an indication of an amount by which the theoretical charge capacity of electrical energy-storage device 64 is diminished as a result of its present discharge rate. For example, in the above-discussed scenario where the present reference capacity is 100 and the baseline reference capacity is 140, applying the foregoing equation would yield a fatigue factor FF of 0.714. This would indicate that the theoretical charge capacity that electrical energy-storage device 64 could have is diminished to 71.4% due to the fatigue effect of a relatively high discharge rate.

In addition to fatigue and the resulting decrease in theoretical capacity, the cumulative amount of electrical energy released from electrical energy-storage device 64 may affect its present charge capacity. Accordingly, the method that information-processing device 66 employs to estimate the present charge capacity may involve estimating how much electrical energy has been released from electrical energy-storage device 64. For example, information-processing device 66 may determine the amount of electrical energy discharged from electrical energy-storage device 64 during a given period of time using the following equation:

DIS=−p×T

Where DIS is the amount of electrical energy discharged, p is the magnitude of power over the period of time, and T is the length of the period of time. Information-processing device 66 may determine the power p based on the signals from voltage sensor 61 and current sensor 63.

Having determined the amount of electrical energy discharged DIS and the fatigue factor FF for a given period of time, information-processing device 66 may use these values to estimate the effects of both the amount of electrical energy discharged and fatigue on the present capacity of the electrical energy-storage device 64 during that period of time. For example, information-processing device 66 may use the following equation to determine a fatigue-adjusted discharge value DIS_{fa}:

DIS_{fa}=DIS×FF

Information-processing device 66 may use the fatigue-adjusted discharge value DIS_{fa} in various ways when estimating the present charge capacity of electrical energy-storage device 64. In some embodiments, information-processing device 66 may use the fatigue-adjusted discharge value to estimate a relative amount by which the present capacity of electrical energy-storage device changed over the subject period of time. For example, information-processing device 66 may use the fatigue adjusted discharge value DIS_{fa} in the following equation to determine a fatigue-adjusted capacity change ΔC_{fa}:

$$Δ {C}_{fa} = \frac{{DIS}_{fa}}{{C}_{full}} \times 100 \%$$

Where, C_{full} is an estimated full capacity of electrical energy-storage device 64. Thus, by calculating the fatigue-adjusted capacity change ΔC_{fa} in this manner, information-processing device 66 may estimate how much the capacity of electrical energy-storage device 64 has decreased over the subject time period on a percentage basis. To keep track of how the present charge capacity of electrical energy-storage device 64 changes over time, information-processing device 66 may repeat the process of executing the foregoing calculations for each of a plurality of successive time periods. In some embodiments, each time it performs the foregoing calculations, information-processing device 66 may determine the fatigue factor FF and the other variables used in the calculations anew.

To determine a present charge capacity Cₚ of electrical energy-storage device 64 based on the estimated changes in the charge capacity over the plurality of time periods, information-processing device 66 may sum the fatigue-adjusted capacity change ΔC_{fa} for each of the time periods:

Cₚ=ΣΔC_{fa}

Methods that information-processing device 66 may use to estimate the present charge capacity Cₚ of electrical energy-storage device 64 are not limited to the examples provided above. For instance, information-processing device 66 may determine the present reference capacity Cᵣₚ and the baseline reference capacity C_{rb} differently than discussed above. The lowest acceptable charge level of electrical energy-storage device 64 may also be determined differently. In addition to a sensed temperature of electrical energy-storage device 64, other variables may be used in determining the lowest acceptable charge level of electrical energy-storage device 64. Alternatively, in some embodiments, the lowest acceptable charge level may be a predetermined fixed value. Additionally, data other than that reflected in FIG. 2 may be used to determine the present reference capacity Cᵣₚ and the baseline reference capacity C_{rb}. Furthermore, information-processing device 66 may use various equations other than the examples provided above to calculate the various values used in estimating the present charge capacity Cₚ of electrical energy-storage device 64.

The disclosed embodiments for estimating the present charge capacity Cₚ of electrical energy-storage device 64 may provide certain advantages. For example, applying the fatigue factor FF to the amount of electrical energy discharged DIS during each time period may help simplify the process of estimating the present charge capacity Cₚ. By dealing with changes in the fatigue factor FF in the calculation of the electrical energy discharged, information-processing device 66 need not repeatedly apply changes in the fatigue factor FF to the theoretical full capacity C_{full} of electrical energy-storage device 64. Additionally, determining fatigue factor FF anew for each of the plurality of time periods before summing the effects may help provide a more refined estimate of the effects of varying discharge rates on the present charge capacity Cₚ of electrical energy-storage device 64.

By facilitating accurate estimation of the present charge capacity Cₚ of electrical energy-storage device 64, the disclosed embodiments may help controls 65 operate power system 10 in a manner that efficiently and effectively meets the needs of the electrical loads 12. For instance, accurately knowing the present charge capacity Cₚ of electrical energy-storage device 64 may facilitate making control decisions like when to use electricity from electrical energy-storage device 64, how much electricity to use from electrical energy-storage device 64, when to use electricity from power source 28, how much electricity to use from power source 28, and when to charge electrical energy-storage device 64.

It will be apparent to those skilled in the art that various modifications and variations can be made in the disclosed system and methods without departing from the scope of the disclosure. Other embodiments of the disclosed system and methods will be apparent to those skilled in the art from consideration of the specification and practice of the system and methods disclosed herein. It is intended that the specification and examples be considered as exemplary only, with a true scope of the disclosure being indicated by the following claims and their equivalents.

What is claimed is:

1. A method of operating a power system with an electrical energy-storage device, the method comprising:
estimating with at least one information-processing device a present charge capacity of the electrical energy-storage device, including
determining an estimated fatigue-adjusted discharge value by determining an estimated amount of electrical energy discharged from the electrical energy-storage device and applying a fatigue factor to the estimated amount of electrical energy discharged, the fatigue factor being determined based on a magnitude of electricity discharged from the electrical energy-storage device; and
estimating the present charge capacity of the electrical energy-storage device based on the estimated fatigue-adjusted discharge value and an estimated full capacity of the electrical energy-storage device.

2. The method of claim 1, wherein the fatigue factor is determined by:
sensing a magnitude of electricity discharged from the electrical energy-storage device;
determining a first reference charge capacity of the electrical energy-storage device based on the sensed magnitude of electricity; and
dividing the first reference charge capacity by a second reference capacity of the electrical energy-storage device.

3. The method of claim 2, wherein the second reference capacity of the electrical energy-storage device is determined based at least in part on a sensed temperature of the electrical energy-storage device.

4. The method of claim 2, wherein applying the fatigue factor to the estimated amount of electrical energy discharged includes multiplying the fatigue factor by the estimated amount of electrical energy discharged.

5. The method of claim 4, wherein estimating the present charge capacity of the electrical energy-storage device includes dividing the estimated fatigue-adjusted discharge value by the estimated full capacity of the electrical energy-storage device.

6. The method of claim 1, wherein estimating the present charge capacity of the electrical energy-storage device includes dividing the estimated fatigue-adjusted discharge value by the estimated full capacity of the electrical energy-storage device.

7. The method of claim 1, wherein applying the fatigue factor to the estimated amount of electrical energy discharged includes multiplying the fatigue factor by the estimated amount of electrical energy discharged.

8. A method of operating a power system with an electrical energy-storage device, the method comprising:
estimating with at least one information-processing device a present charge capacity of the electrical energy-storage device, including
for each of a plurality of time periods
determining a fatigue factor based at least in part on a magnitude of electricity discharged from the electrical energy-storage device,
applying the fatigue factor to a first value related to charge capacity of the electrical energy-storage device to determine a second value related to charge capacity of the electrical energy-storage device; and
summing the second value over the plurality of time periods to determine a third value related to charge capacity of the electrical energy-storage device.

9. The method of claim 8, wherein the first value is an amount of electrical energy discharged from the electrical energy-storage device.

10. The method of claim 9, wherein applying the fatigue factor to the first value includes multiplying the fatigue factor by the amount of electrical energy discharged from the electrical energy-storage device.

11. The method of claim 10, wherein determining the second value further includes dividing the product of the fatigue factor and the amount of electrical energy discharged from the electrical energy-storage device by an estimated full capacity of the electrical energy-storage device.

12. The method of claim 11, wherein the fatigue factor is determined by:
sensing a magnitude of electricity discharged from the electrical energy-storage device;
determining a first reference charge capacity of the electrical energy-storage device based on the sensed magnitude of electricity; and
dividing the first reference charge capacity by a second reference capacity of the electrical energy-storage device.

13. The method of claim 12, wherein the second reference capacity of the electrical energy-storage device is determined based at least in part on a sensed temperature of the electrical energy-storage device.

14. The method of claim 8, wherein the fatigue factor is determined by:
sensing a magnitude of electricity discharged from the electrical energy-storage device;
determining a first reference charge capacity of the electrical energy-storage device based on the sensed magnitude of electricity; and
dividing the first reference charge capacity by a second reference capacity of the electrical energy-storage device.

15. The method of claim 14, wherein the second reference capacity of the electrical energy-storage device is determined based at least in part on a sensed temperature of the electrical energy-storage device.

16. A power system, comprising:
an electrical energy-storage device; and
at least one information-processing device configured to estimate a present charge capacity of the electrical energy-storage device by
determining an estimated fatigue-adjusted discharge value by determining an estimated amount of electrical energy discharged from the electrical energy-storage device and applying a fatigue factor to the estimated amount of electrical energy discharged, the fatigue factor being determined based on a magnitude of electricity discharged from the electrical energy-storage device, and
estimating the present charge capacity of the electrical energy-storage device based on the estimated fatigue-adjusted discharge value and an estimated full capacity of the electrical energy-storage device.

17. The power system of claim 16, wherein estimating the present charge capacity of the electrical energy-storage device based on the estimated fatigue-adjusted discharge value and the estimated full capacity of the electrical energy-storage device includes
dividing the estimated fatigue-adjusted discharge value by the estimated full capacity of the electrical energy-storage device for each of a plurality of time periods to determine a fatigue-adjusted capacity change for each of the plurality of time periods; and
summing the fatigue-adjusted capacity change for each of the plurality of time periods.

18. The power system of claim 16, wherein applying the fatigue factor to the estimated amount of electrical energy discharged includes multiplying the fatigue factor by the estimated amount of electrical energy discharged.

19. The power system of claim 16, wherein the fatigue factor is determined by:
sensing a magnitude of electricity discharged from the electrical energy-storage device;
determining a first reference charge capacity of the electrical energy-storage device based on the sensed magnitude of electricity; and
dividing the first reference charge capacity by a second reference capacity of the electrical energy-storage device.

20. The power system of claim 16, wherein the second reference capacity of the electrical energy-storage device is determined based at least in part on a sensed temperature of the electrical energy-storage device.
